(19) United States
(12) Patent Application Publication
(10) Pub. No.: US 2022/0074779 A1
(43) Pub. Date: Mar. 10, 2022

(54) NONINTRUSIVE VESSEL LEVEL MEASUREMENT

(71) Applicant: Alliance for Sustainable Energy, LLC, Golden, CO (US)

(72) Inventors: David Andrew SIEVERS, Golden, CO (US); James Joseph LISCHESKE, Arvada, CO (US)

(21) Appl. No.: 17/467,689

(22) Filed: Sep. 7, 2021

Related U.S. Application Data
(60) Provisional application No. 63/074,846, filed on Sep. 4, 2020.

(51) Int. Cl. G01F 23/18; G01F 23/00

(52) U.S. Cl. CPC G01F 23/18; G01F 23/0076

(57) ABSTRACT

Described herein are systems and methods for determining the volume of liquid and/or solids present in a vessel by flowing gas to or from an accumulator vessel and using the ideal gas law to determine the volume of gas (e.g., void space) present in the vessel. Advantageously, the described systems and methods and nonintrusive and may be useful for applications in which the level of liquid/solids in the vessel are unstable or where traditional volumetric measurements would interfere with internal processes, such as agitation.

### CROSS-REFERENCE TO RELATED APPLICATIONS

This application claims priority from U.S. Provisional Patent Application No. 63/074,846, filed on Sep. 4, 2020, the contents of which are incorporated herein by reference in their entirety.

### CONTRACTUAL ORIGIN

This invention was made with government support under Contract No. DE-AC36-08GO28308 awarded by the Department of Energy. The government has certain rights in the invention.

### BACKGROUND

Processing equipment used with granular solids or solids slurries may involve vessels that have complete-sweep agitators (i.e., agitators that fully sweep the entire volume of the process vessel). This presents challenges when selecting and implementing commercially-available process level measurement instrumentation. For example, mechanical level floats cannot be used since they would interfere with agitator movement. Other methods that may seem non-invasive such as radar or sonar measurements of liquid/gas interface distance from top of the vessel also cannot be used since the agitator will produce erroneous reflections and poor level measurement. Additionally, differential pressure measurement will not work since diaphragm seals are necessary when processing solids slurries and these measurement diaphragms need to be close to or flush with the vessel wall. With a full-sweep agitator, these diaphragms would be subjected to mechanical force when paddles are swept by the sensors and also lead to erroneous values and even possible mechanical damage. The only other options available to this application are load cells that measure gross vessel weight and nuclear level gauges that can sense through the vessel walls and agitator.

In certain applications, such as with small equipment, load cells are difficult to use due to low process weight-to-empty vessel weight ratio (low signal to noise) or external vessel connections (especially at smaller scales where connected tubing may be bumped and change the vessel weight reading). Nuclear level gauges are expensive and require licensure to operate and require tedious calibration and possibly additional calculations if the vessel is not uniformly filled to a liquid/gas interface as such with thick slurries that may stick to the walls and form topography at the interface.

In can be seen from the foregoing that there remains a need in the art for systems and methods for determining liquid and/or solid volume in agitated or non-level tank applications that would otherwise be difficult to quantify.

### SUMMARY

Described herein are systems and methods for determining the volume of liquid and/or solids present in a vessel by flowing gas to or from an accumulator vessel and using the ideal gas law to determine the volume of gas (e.g., void space) present in the vessel. Advantageously, the described systems and methods and nonintrusive and may be useful for applications in which the level of liquid/solids in the vessel are unstable or where traditional volumetric measurements would interfere with internal processes, such as agitation.

In an aspect, provided is a method comprising: a) altering a pressure of an accumulator vessel in fluid communication with a primary vessel by adding or removing a gas, thereby generating a pressure differential between the accumulator vessel and the vessel; b) sealing the accumulator vessel and the primary vessel from exterior fluid flow; c) flowing a volume of gas from the accumulator vessel to the primary vessel or flowing a volume of gas from the primary vessel to the accumulator vessel; d) determining the volume of gas in the primary vessel based on the change in pressure in the primary vessel and the accumulator vessel.

The method may further comprise: e) determining the volume of liquid and/or solids in the primary vessel by subtracting the determine volume of gas in the primary vessel from the total volume of the primary vessel.

For many applications and depending on desired accuracy, temperature may be assumed to be constant both between the two tanks and between the pressurization and equalization phases. However, the step of determining the volume of gas in the primary vessel may further comprise accounting from a difference in temperature between the primary vessel and the accumulator vessel.

The step of determining the volume of the vessel may be accomplished by determining the volume of gas in the primary vessel, as defined by the formula:

$${V}_{P V} = {V}_{A V} \frac{{P}_{AV , o} - {P}_{AV , 1}}{{P}_{PV , 1} - {P}_{PV , o}} or {V}_{P V} = {V}_{A V} \frac{{T}_{P V}}{{T}_{A V}} \frac{{P}_{AV , o} - {P}_{AV , 1}}{{P}_{PV , 1} - {P}_{PV , o}}$$

wherein V_{PV} is the volume of gas in the primary vessel, V_{AV} is the volume of the accumulator vessel, P_{AV,0} is the initial gauge pressure of the accumulator vessel, P_{AV,1} is the final gauge pressure of the accumulator vessel, P_{PV,1} is the final gauge pressure of the primary vessel and P_{PV,0} is the initial gauge pressure of the primary vessel, T_{PV} in the final temperature of the primary vessel, and T_{AV} is the final temperature of the accumulator vessel. Temperatures are absolute scale (K or R). Alternatively, absolute pressure may be used in place of gauge pressure (one scale for all).

The gas used may behave as an ideal gas at the operating conditions of the primary vessel. The gas may be an inert gas or air. The pressure differential between the primary vessel and the accumulator vessel may be greater than or equal to 10%, 25%, 50%, 100% or 200%. The liquids and/or solids in the primary vessel may be undergoing agitation, including during the pressurization and equalization phases.

In an aspect, provided is a system comprising: a) an accumulator vessel having a first temperature gauge and a first pressure gauge; b) a primary vessel in fluid communication with the accumulator vessel and having a second temperature gauge and a second pressure gauge; and c) a computer processor in communication with the first temperature gauge, the first pressure gauge, the second temperature gauge, the second pressure gauge; wherein the processor determines the volume of liquid and/or solids in the primary vessel.

The system may be configured to isolate the primary vessel and accumulator vessel from exterior fluid flow, to generate a pressure differential between the primary vessel and accumulator vessel, and to equalize pressure between the primary vessel and the accumulator vessel, for example, by the inclusion and operation of multiple valves.

The processor may determine the volume of liquids and/or solids in the primary vessel based on the formula:

$${V}_{L S} = {V}_{Total} - {V}_{A V} \frac{{T}_{P V}}{{T}_{A V}} \frac{{P}_{AV , o} - {P}_{AV , 1}}{{P}_{PV , 1} - {P}_{PV , o}} ;$$

wherein V_{LS} is the volume of liquids and/or solids in the primary vessel, V_{Total} is the volume of the primary vessel, V_{AV} is the volume of the accumulator vessel, P_{AV,0} is the initial gauge pressure of the accumulator vessel, P_{AV,1} is the final gauge pressure of the accumulator vessel, P_{PV,1} is the final gauge pressure of the primary vessel and P_{PV,0} is the initial gauge pressure of the primary vessel, T_{PV} in the final temperature of the primary vessel, and T_{AV} is the final temperature of the accumulator vessel. The processor may determine the volume of liquid and/or solids in the tank at a set time interval or as requested by the process or operator.

### BRIEF DESCRIPTION OF DRAWINGS

Some embodiments are illustrated in referenced figures of the drawings. It is intended that the embodiments and figures disclosed herein are to be considered illustrative rather than limiting.

FIG. 1 provides an exemplary schematic of the systems described herein.

FIG. 2 provides a schematic and further describes valve configuration for generating a pressure gradient and then equalizing the pressure between the accumulator and the primary vessel. For the vent valve c denotes closed and o denotes open. For the accumulator valve f denotes fill (for accumulating pressure) and e denotes equalize.

FIG. 3 provides experimental data at temperatures ranging from 23° C. to 81° C. for compressed air and a water/slurry mixture. The graph provides actual volume of slurry on the x-axis and calculated volume on the y-axis.

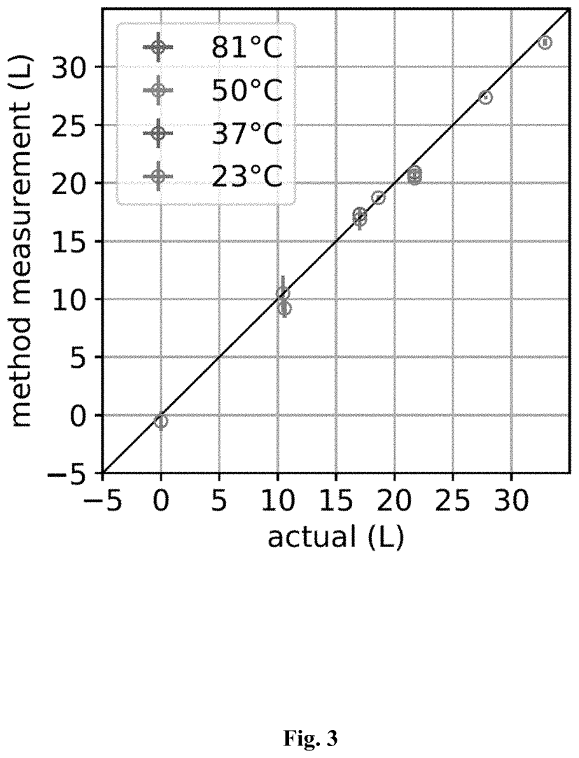

FIG. 4 provides additional experimental data. The graph provides actual volume of slurry on the x-axis and calculated volume on the y-axis.

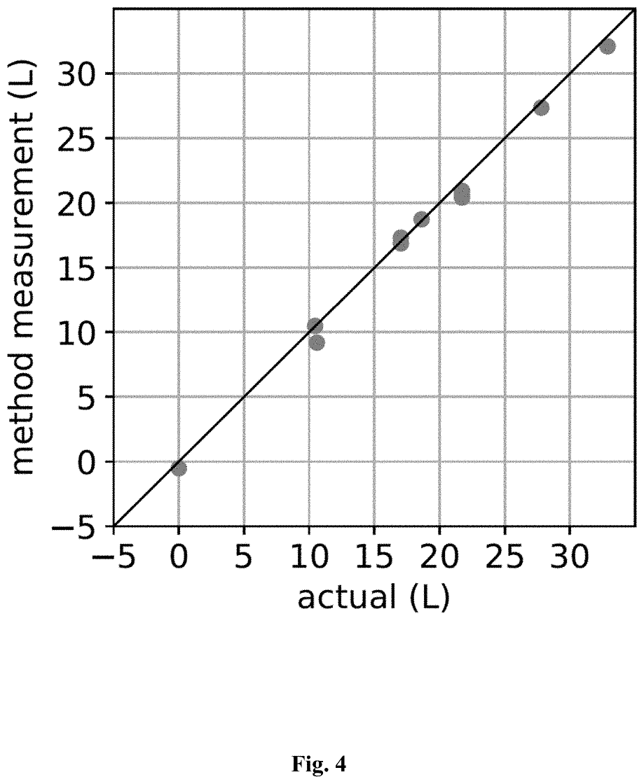

### REFERENCE NUMERALS

100 Primary Vessel
110 Accumulator Vessel
120 Pressure Gauge
130 Temperature Gauge/Thermometer
140 Valve

### DETAILED DESCRIPTION

The embodiments described herein should not necessarily be construed as limited to addressing any of the particular problems or deficiencies discussed herein. References in the specification to “one embodiment”, “an embodiment”, “an example embodiment”, “some embodiments”, etc., indicate that the embodiment described may include a particular feature, structure, or characteristic, but every embodiment may not necessarily include the particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to affect such feature, structure, or characteristic in connection with other embodiments whether or not explicitly described.

As used herein the term “substantially” is used to indicate that exact values are not necessarily attainable. By way of example, one of ordinary skill in the art will understand that in some chemical reactions 100% conversion of a reactant is possible, yet unlikely. Most of a reactant may be converted to a product and conversion of the reactant may asymptotically approach 100% conversion. So, although from a practical perspective 100% of the reactant is converted, from a technical perspective, a small and sometimes difficult to define amount remains. For this example of a chemical reactant, that amount may be relatively easily defined by the detection limits of the instrument used to test for it. However, in many cases, this amount may not be easily defined, hence the use of the term “substantially”. In some embodiments of the present invention, the term “substantially” is defined as approaching a specific numeric value or target to within 20%, 15%, 10%, 5%, or within 1% of the value or target. In further embodiments of the present invention, the term “substantially” is defined as approaching a specific numeric value or target to within 1%, 0.9%, 0.8%, 0.7%, 0.6%, 0.5%, 0.4%, 0.3%, 0.2%, or 0.1% of the value or target.

As used herein, the term “about” is used to indicate that exact values are not necessarily attainable. Therefore, the term “about” is used to indicate this uncertainty limit. In some embodiments of the present invention, the term “about” is used to indicate an uncertainty limit of less than or equal to ±20%, ±15%, ±10%, ±5%, or ±1% of a specific numeric value or target. In some embodiments of the present invention, the term “about” is used to indicate an uncertainty limit of less than or equal to ±1%, ±0.9%, ±0.8%, ±0.7%, ±0.6%, ±0.5%, ±0.4%, ±0.3%, ±0.2%, or ±0.1% of a specific numeric value or target.

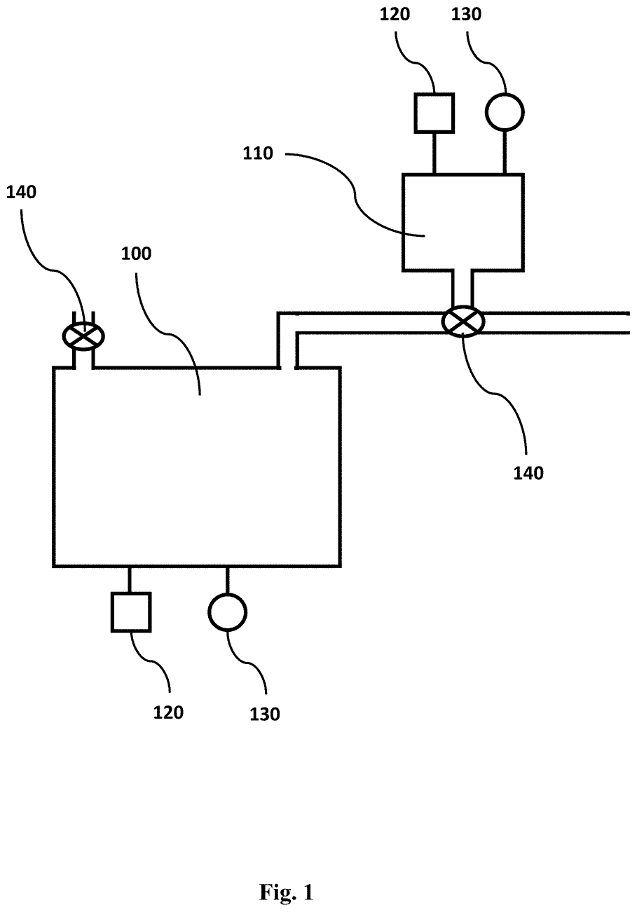

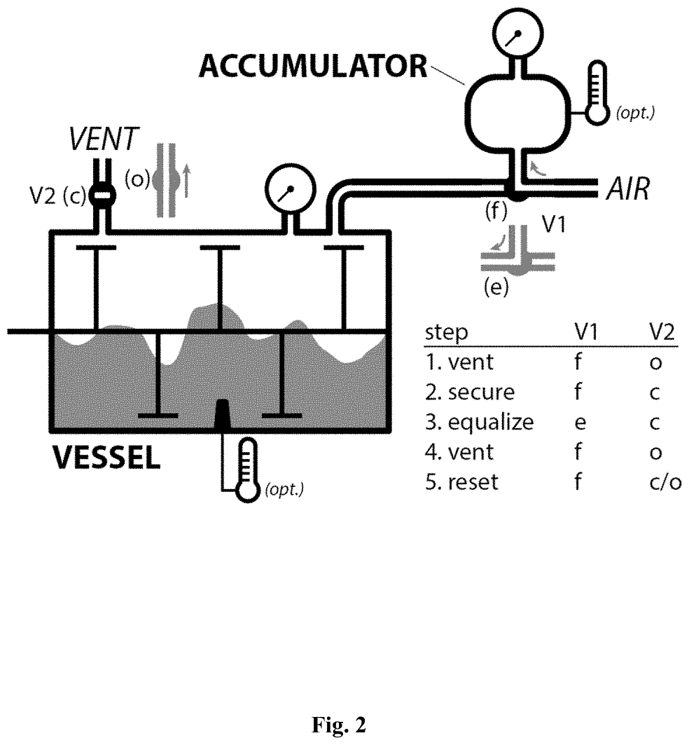

FIG. 1 provides an example of a system that may be used to determine liquid or slurry volume in the primary vessel 100 as described herein. The accumulator vessel 110 may be pressurized or depressurized to generate a pressure gradient between the primary vessel 100 and the accumulator vessel 110. Both vessels have a pressure gauge 120. For more accurate volume calculations, temperature differences may be accounted for by incorporating a temperature gauge 130 on both vessels as well. Two valves 140 can be used to isolate the accumulator vessel 110 from the primary vessel 100 as well as isolate the system from external fluids and equalize pressure between the two vessels, which is further illustrated in FIG. 2.

The provided discussion and examples have been presented for purposes of illustration and description. The foregoing is not intended to limit the aspects, embodiments, or configurations to the form or forms disclosed herein. In the foregoing Detailed Description for example, various features of the aspects, embodiments, or configurations are grouped together in one or more embodiments, configurations, or aspects for the purpose of streamlining the disclosure. The features of the aspects, embodiments, or configurations, may be combined in alternate aspects, embodiments, or configurations other than those discussed above. This method of disclosure is not to be interpreted as reflecting an intention that the aspects, embodiments, or configurations require more features than are expressly recited in each claim. Rather, as the following claims reflect, inventive aspects lie in less than all features of a single foregoing disclosed embodiment, configuration, or aspect. While certain aspects of conventional technology have been discussed to facilitate disclosure of some embodiments of the present invention, the Applicants in no way disclaim these technical aspects, and it is contemplated that the claimed invention may encompass one or more of the conventional technical aspects discussed herein. Thus, the following claims are hereby incorporated into this Detailed Description, with each claim standing on its own as a separate aspect, embodiment, or configuration.

Disclosed herein are methods for determining the process material volume within a vessel by measuring the gas void space within an enclosed process vessel that may contain varying amounts of liquid or solid process material. The actual volume of process material then may be calculated by knowing the empty vessel volume and the measured gas void volume. To accomplish the measurement of vessel void volume, an air accumulator vessel of somewhat smaller but known volume is pressurized with compressed air, then equalized with the closed (unvented) process vessel as depicted in the attached figure. By measuring the initial and final pressures within the process vessel and accumulator, void volume may be calculated. Conservation of mass is applied between the two volumes (process vessel and accumulator) and the ideal gas law is used to relate measured pressures and temperatures with volumes. The attached mathematical derivation arrives at a final equation to calculate the vessel void space volume using measured gauge pressures (as opposed to absolute pressures) and optionally measured temperatures (K or R).

The equations and calculations described herein are derived from the ideal gas law, PV=nRT. Where P is pressure, V is volume, n is molar quantity, R is a constant and T is temperature. The subscript PV denotes the primary vessel that contains a mixture of liquids and/or solids and a gaseous void space, the subscript AV denotes the accumulator or the accumulator vessel.

Implementation of this method utilizes inexpensive pressure instrumentation to measure the initial (subscript 0) and final (subscript 1) pressures of the vessel and accumulator, and a selector valve to either refill the accumulator or equalize the accumulator with the process vessel. A vent valve is also used on the process vessel to vent excess pressure after measurement. Optionally, temperature compensation may be made also using temperature probes in the process vessel and the accumulator (which may be assumed at room temperature if no probe is present).

Conservation of mass results in the molar quantity being conserved between the two vessels before and after equalization:

n_{AV,0}+n_{PV,0}=n_{AV,1}+n_{PV,1} (1)

Solving the ideal gas law for n and substituting the result leads to:

$$\frac{{P}_{AV , o} {V}_{A V}}{{T}_{A V}} + \frac{{P}_{PV , o} {V}_{P V}}{{T}_{P V}} = \frac{{P}_{AV , 1} {V}_{A V}}{{T}_{A V}} + \frac{{P}_{PV , 1} {V}_{P V}}{{T}_{P V}} \qquad ( 2 )$$

With the assumption that temperature remains constant in both vessels between the pressurization and equalization phases. Equation 2 can be simplified to:

$$\frac{{V}_{A V}}{{T}_{A V}} ( {P}_{A V , 0} - {P}_{A V , 1} ) = \frac{{V}_{P V}}{{T}_{P V}} ( {P}_{P V , 1} - {P}_{P V , 0} ) \qquad ( 3 )$$

Solving Equation 3 for V_{PV} yields:

$${V}_{P V} = {V}_{A V} \frac{{T}_{P V}}{{T}_{A V}} \frac{{P}_{AV , o} - {P}_{AV , 1}}{{P}_{PV , 1} - {P}_{PV , o}} \qquad ( 4 )$$

Where V_{PV} is the volume of gas present in the primary vessel. While the ideal gas law generally requires the use of absolute pressures, in many applications the ambient pressure will be constant on both the primary vessel and the accumulator vessel over the short time needed to equalize, therefore gauge pressure may be used. Taking the known total volume of the primary vessel (V_{Total}), the volume of liquids and/or solids (V_{SL}) present in the primary vessel can be expressed as:

$${V}_{S L} = {V}_{T o t a l} - {V}_{A V} \frac{{T}_{P V}}{{T}_{A V}} \frac{{P}_{AV , o} - {P}_{AV , 1}}{{P}_{PV , 1} - {P}_{PV , o}} . \qquad ( 5 )$$

The end goal is not to measure the physical level in the vessel, but to measure the volume holdup. To accomplish this goal, measurement of the void space of gas and comparison to the known empty vessel volume is all that is required. The systems and methods described herein are capable of directly measuring that gas void space using low-cost hardware and instruments.

In certain applications, load cells are difficult to use due to low process weight-to-empty vessel weight ratio (low signal to noise) or external vessel connections (especially at smaller scales where connected tubing may be bumped and change the vessel weight reading). Nuclear level gauges are expensive and require licensure to operate and require tedious calibration and possibly additional calculations if the vessel is not uniformly filled to a liquid/gas interface as such with thick slurries that may stick to the walls and form topography at the interface.

The end goal is not to measure the physical level in the vessel, but to measure the volume holdup. To accomplish this goal, measurement of the void space of gas and comparison to the known empty vessel volume is all that is required. The invention documented here is capable of directly measuring that gas void space and using low-cost hardware and instruments.

There are several different mature and commercially-available techniques to measure level or fill in a vessel, either by physical elevation of a liquid/gas interface or by mass. Elevation instruments include physical floats, radar, sonar, capacitance, and differential pressure (liquid head), but these are incompatible with a full-sweep agitator due to interference and mechanical forces. Mass measurement techniques available include load cells to measure the gross weight of the vessel with process fluid and also nuclear level gauges that measure the radiation absorption by process fluid. With small size vessels, such as pilot-scale equipment, the signal to noise ratio is low with load cells due to most of the measured mass owing to the vessel empty weight. External piping/tubing connections that can be bumped or moved also make using load cells problematic. Nuclear level gauges are expensive and also are difficult to interpret the results if the vessel is not uniformly filled.

The terms and expressions which have been employed herein are used as terms of description and not of limitation, and there is no intention in the use of such terms and expressions of excluding any equivalents of the features shown and described or portions thereof, but it is recognized that various modifications are possible within the scope of the invention claimed. Thus, it should be understood that although the present invention has been specifically disclosed by preferred embodiments, exemplary embodiments and optional features, modification and variation of the concepts herein disclosed may be resorted to by those skilled in the art, and that such modifications and variations are considered to be within the scope of this invention as defined by the appended claims. The specific embodiments provided herein are examples of useful embodiments of the present invention and it will be apparent to one skilled in the art that the present invention may be carried out using a large number of variations of the devices, device components, methods steps set forth in the present description. As will be obvious to one of skill in the art, methods, and devices useful for the present methods can include a large number of optional composition and processing elements and steps.

As used herein and in the appended claims, the singular forms “a”, “an”, and “the” include plural reference unless the context clearly dictates otherwise. Thus, for example, reference to “a cell” includes a plurality of such cells and equivalents thereof known to those skilled in the art. As well, the terms “a” (or “an”), “one or more” and “at least one” can be used interchangeably herein. It is also to be noted that the terms “comprising”, “including”, and “having” can be used interchangeably. The expression “of any of claims XX-YY” (wherein XX and YY refer to claim numbers) is intended to provide a multiple dependent claim in the alternative form, and in some embodiments is interchangeable with the expression “as in any one of claims XX-YY.”

When a group of substituents is disclosed herein, it is understood that all individual members of that group and all subgroups, are disclosed separately. When a Markush group or other grouping is used herein, all individual members of the group and all combinations and subcombinations possible of the group are intended to be individually included in the disclosure. For example, when a device is set forth disclosing a range of materials, device components, and/or device configurations, the description is intended to include specific reference of each combination and/or variation corresponding to the disclosed range.

Every formulation or combination of components described or exemplified herein can be used to practice the invention, unless otherwise stated.

Whenever a range is given in the specification, for example, a density range, a number range, a temperature range, a time range, or a composition or concentration range, all intermediate ranges, and subranges, as well as all individual values included in the ranges given are intended to be included in the disclosure. It will be understood that any subranges or individual values in a range or subrange that are included in the description herein can be excluded from the claims herein.

All patents and publications mentioned in the specification are indicative of the levels of skill of those skilled in the art to which the invention pertains. References cited herein are incorporated by reference herein in their entirety to indicate the state of the art as of their publication or filing date and it is intended that this information can be employed herein, if needed, to exclude specific embodiments that are in the prior art. For example, when composition of matter is claimed, it should be understood that compounds known and available in the art prior to Applicant's invention, including compounds for which an enabling disclosure is provided in the references cited herein, are not intended to be included in the composition of matter claims herein.

As used herein, “comprising” is synonymous with “including,” “containing,” or “characterized by,” and is inclusive or open-ended and does not exclude additional, unrecited elements or method steps. As used herein, “consisting of” excludes any element, step, or ingredient not specified in the claim element. As used herein, “consisting essentially of” does not exclude materials or steps that do not materially affect the basic and novel characteristics of the claim. In each instance herein any of the terms “comprising”, “consisting essentially of” and “consisting of” may be replaced with either of the other two terms. The invention illustratively described herein suitably may be practiced in the absence of any element or elements, limitation or limitations which is not specifically disclosed herein.

All art-known functional equivalents, of any such materials and methods are intended to be included in this invention. The terms and expressions which have been employed are used as terms of description and not of limitation, and there is no intention that in the use of such terms and expressions of excluding any equivalents of the features shown and described or portions thereof, but it is recognized that various modifications are possible within the scope of the invention claimed. Thus, it should be understood that although the present invention has been specifically disclosed by preferred embodiments and optional features, modification and variation of the concepts herein disclosed may be resorted to by those skilled in the art, and that such modifications and variations are considered to be within the scope of this invention as defined by the appended claims.

What is claimed is:

1. A method comprising:
altering a pressure of an accumulator vessel in fluid communication with a primary vessel by adding or removing a gas, thereby generating a pressure differential between the accumulator vessel and the vessel;
sealing the accumulator vessel and the primary vessel from exterior fluid flow;
flowing a volume of gas from the accumulator vessel to the primary vessel or flowing a volume of gas from the primary vessel to the accumulator vessel;
determining the volume of gas in the primary vessel based on the change in pressure in the primary vessel and the accumulator vessel.

2. The method of claim 1 further comprising:
determining the volume of liquid and/or solids in the primary vessel by subtracting the determine volume of gas in the primary vessel from the total volume of the primary vessel.

3. The method of claim 1, wherein the step of determining the volume of gas in the primary vessel further comprises accounting from a difference in temperature between the primary vessel and the accumulator vessel.

4. The method of claim 1, wherein the step of determining the volume of gas in the primary vessel is performed using the formula:
$${V}_{P V} = {V}_{A V} \frac{{P}_{AV , o} - {P}_{AV , 1}}{{P}_{PV , 1} - {P}_{PV , o}} ;$$
wherein V_{PV} is the volume of gas in the primary vessel, V_{AV} is the volume of the accumulator vessel, P_{AV,0} is the initial gauge pressure of the accumulator vessel, P_{AV,1} is the final gauge pressure of the accumulator vessel, and P_{PV,1} is the final gauge pressure of the primary vessel and P_{PV,0} is the initial gauge pressure of the primary vessel.

5. The method of claim 4, wherein P_{AV,0} is the initial absolute pressure of the accumulator vessel, P_{AV,1} is the final absolute pressure of the accumulator vessel, and P_{PV,1} is the final absolute pressure of the primary vessel and P_{PV,0} is the initial absolute pressure of the primary vessel.

6. The method of claim 3, wherein the step of determining the volume of gas in the primary vessel is performed using the formula:
$${V}_{P V} = {V}_{A V} \frac{{T}_{P V}}{{T}_{A V}} \frac{{P}_{AV , o} - {P}_{AV , 1}}{{P}_{PV , 1} - {P}_{PV , o}} ;$$
wherein V_{PV} is the volume of gas in the primary vessel, V_{AV} is the volume of the accumulator vessel, P_{AV,0} is the initial gauge pressure of the accumulator vessel, P_{AV,1} is the final gauge pressure of the accumulator vessel, P_{PV,1} is the final gauge pressure of the primary vessel and P_{PV,0} is the initial gauge pressure of the primary vessel, T_{PV} is the final absolute temperature of the primary vessel, and T_{AV} is the final absolute temperature of the accumulator vessel.

7. The method of claim 6, wherein P_{AV,0} is the initial absolute pressure of the accumulator vessel, P_{AV,1} is the final absolute pressure of the accumulator vessel, and P_{PV,1} is the final absolute pressure of the primary vessel and P_{PV,0} is the initial absolute pressure of the primary vessel.

8. The method of claim 1, wherein the gas behaves as an ideal gas at the operating conditions of the primary vessel.

9. The method of claim 1, wherein the gas is an inert gas.

10. The method of claim 1, wherein the gas is air.

11. The method of claim 1, wherein the pressure differential is greater than or equal to 10%.

12. The method of claim 2, wherein the liquid and/or solids in the primary vessel are undergoing agitation.

13. A system comprising:
an accumulator vessel having a first temperature gauge and a first pressure gauge;
a primary vessel in fluid communication with the accumulator vessel and having a second temperature gauge and a second pressure gauge; and
a processor in communication with the first temperature gauge, the first pressure gauge, the second temperature gauge, the second pressure gage;
wherein the processor determines the volume of liquid and/or solids in the primary vessel.

14. The system of claim 14, wherein the system is configured to isolate the primary vessel and accumulator vessel from exterior fluid flow, to generate a pressure differential between the primary vessel and accumulator vessel, and to equalize pressure between the primary vessel and the accumulator vessel.

15. The system of claim 13, wherein the processor determines the volume of liquids and/or solids in the primary vessel based on the formula:
$${V}_{L S} = {V}_{T o t a l} - {V}_{A V} \frac{{T}_{P V}}{{T}_{A V}} \frac{{P}_{AV , o} - {P}_{AV , 1}}{{P}_{PV , 1} - {P}_{PV , o}} ;$$
wherein V_{LS} is the volume of liquids and/or solids in the primary vessel, V_{Total} is the volume of the primary vessel, V_{AV} is the volume of the accumulator vessel, P_{AV,0} is the initial gauge pressure of the accumulator vessel, P_{AV,1} is the final gauge pressure of the accumulator vessel, P_{PV,1} is the final gauge pressure of the primary vessel and P_{PV,0} is the initial gauge pressure of the primary vessel, T_{PV} is the final absolute temperature of the primary vessel, and T_{AV} is the final absolute temperature of the accumulator vessel.

16. The system of claim 13, wherein the processor determines the volume of liquid and/or solids in the tank at a set time interval.
